(19) United States
(12) Patent Application Publication
(10) Pub. No.: US 2026/0201156 A1
(43) Pub. Date: Jul. 16, 2026

(54) POLYPROPYLENE RESIN COMPOSITION FOR IMPROVING SURFACE QUALITY OF MOLDED ARTICLE AND ENHANCING INJECTION MOLDABILITY, AND MOLDED ARTICLE THEREOF

(71) Applicants: Hyundai Motor Company, Seoul (KR); Kia Corporation, Seoul (KR); BGFecomaterials, Hwaseong-si (KR)

(72) Inventors: YongBeom Lee, Hwaseong-si (KR); HeeJoon Lee, Hwaseong-si (KR); Young Ho Choi, Hwaseong-si (KR); Jong Seok Jang, Cheonan-si (KR); Se Jong Hwang, Osan-si (KR); Sang Mok Kim, Incheon (KR)

(73) Assignees: Hyundai Motor Company, Seoul (KR); Kia Corporation, Seoul (KR); BGFecomaterials, Hwaseong-si (KR)

(21) Appl. No.: 19/204,243

(22) Filed: May 9, 2025

(30) Foreign Application Priority Data
Jan. 14, 2025 (KR) 10-2025-0005118

(51) Int. Cl. C08L 23/16; B29C 45/00; B29C 45/13; B29K 23/00; B29K 105/26; C08K 3/04; C08K 3/08; C08K 3/22; C08K 3/34; C08K 5/13; C08K 5/20; C08K 5/524

(52) U.S. Cl. CPC C08L 23/16; B29C 45/0001; C08K 3/04; C08K 3/22; C08K 3/34; C08K 5/13; C08K 5/524; B29C 2045/135; B29K 2023/16; B29K 2105/26; C08K 2003/0812; C08K 2003/2241; C08K 5/20; C08K 2201/005; C08L 2205/025; C08L 2205/035

(57) ABSTRACT

The present disclosure relates to a polypropylene resin composition for improving the surface quality of a molded article and enhancing injection moldability. The polypropylene resin composition of the present disclosure minimizes the shear stress generated in a cavity and has high viscoelasticity, which induces smooth flow of a recycled material and prevents the occurrence of flow marks on the molded article. Additionally, the polypropylene resin composition of the present disclosure may exhibit improved processability and aesthetics during two-shot injection molding.

### CROSS-REFERENCE TO RELATED APPLICATION

This present application claims the benefit of priority to Korean Patent Application No. 10-2025-0005118 filed on Jan. 14, 2025, in the Korean Intellectual Property Office, the entire disclosure of which is incorporated herein by reference in its entirety.

### FIELD

The present disclosure relates to a polypropylene resin composition, and more particularly, to a polypropylene resin composition for improving the surface quality of a molded article and enhancing injection moldability, and molded article thereof.

### BACKGROUND

As the demand for manufacturing cost reduction and environmental sustainability becomes increasingly stringent, the automotive industry is prioritizing enhancements in production efficiency alongside the integration of eco-friendly manufacturing processes. A particularly promising area of development involves the creation of unpainted exterior components, which effectively eliminate the need for traditional painting processes. This innovative approach is emerging as a pivotal technology in addressing the dual imperatives of cost efficiency and environmental stewardship. Unpainted components not only deliver superior surface quality—thereby maintaining aesthetic and functional standards—but also obviate the need for separate painting operations. This advancement yields significant advantages, including substantial cost savings and a markedly reduced environmental footprint. By adopting unpainted technologies, automotive manufacturers can align with contemporary demands for sustainability while simultaneously optimizing their operational workflows.

Polypropylene (PP) is extensively utilized not only in the manufacturing of automotive interior and exterior components but also across the electrical and electronic sectors. This widespread adoption can be attributed to its advantageous characteristics, including low cost, lightweight composition, enhanced durability, and robust mechanical strength. However, the production of unpainted articles composed of polypropylene resin presents challenges, particularly concerning surface defects that may arise during the injection molding process. These defects, commonly known as flow marks or tiger marks, manifest as periodic streaks on the surface of injection-molded components, appearing in alignment with the resin flow direction. Such imperfections occur as a result of fluctuations in resin flow within the mold, coupled with solidification processes occurring at the flow front. The presence of flow marks significantly compromises the surface quality of molded articles, thereby rendering them unsuitable for applications in high-end exterior components where aesthetic and functional standards are paramount.

Meanwhile, there has been a notable increase in the adoption of recycled materials aimed at fostering resource circulation and enhancing environmental protection. However, while recycling provides important ecological benefits, it is crucial to acknowledge that recycled materials often exhibit inferior mechanical properties compared to their virgin counterparts. Additionally, the use of recycled materials can lead to elevated emissions of harmful volatile organic compounds (VOCs), which include substances such as formaldehyde, acetaldehyde, benzene, toluene, xylene, ethylbenzene, and styrene. The presence of these VOCs raises significant health concerns, as they may pose potential risks to users' health and generate undesirable odors, which can result in discomfort and dissatisfaction. Consequently, these factors present challenges for the application of recycled materials in automotive vehicles, as manufacturers must balance environmental benefits against possible adverse effects on user experience and safety.

To address the limitations associated with recycled materials, research is increasingly focusing on two-shot injection molding techniques. In this process, recycled materials are utilized for the inner layer, while virgin polymers serve as the surface layer. Current literature on two-shot injection molding predominantly emphasizes advancements in injection equipment and control technologies. However, there is a critical need for formulating resin compositions appropriate for the surface layer. Such developments are essential not only to facilitate the injection molding process, but also to enhance the aesthetic quality of the finished molded articles. The present disclosure describes a polypropylene resin composition designed to improve the surface quality of molded articles and enhance injection moldability, thereby optimizing the surface layer's material properties, which allows manufacturers to effectively mitigate the disadvantages of recycled materials while maintaining both performance and visual appeal.

### SUMMARY

Accordingly, the present disclosure describes a polypropylene resin composition that facilitates enhanced cavity filling during two-shot injection molding and prevents the occurrence of flow marks. The compositions described herein not only promotes seamless integration of materials in the molding process, but also enables the production of molded articles that can remain unpainted without compromising their aesthetic quality.

Additionally, the present disclosure describes a polypropylene resin composition that is applicable within the green technology sector, particularly for the production of automotive interior and exterior components utilizing recycled materials. The compositions described herein are designed to facilitate the manufacturing of molded articles that do not require painting, thereby further promoting sustainability by reducing material waste and environmental impact. By leveraging recycled content while maintaining high performance and aesthetic standards, this resin composition addresses the growing demand for eco-friendly solutions in the automotive industry.

An aspect of the present disclosure provides a polypropylene resin composition including 30 to 80 wt. % of a polypropylene-based resin, 5 to 30 wt. % of an ethylene-α-olefin copolymer, 1 to 5 wt. % of an anti-scratch additive, 5 to 35 wt. % of an inorganic filler, and 0.1 to 0.5 wt. % of a processing aid.

In embodiments, the polypropylene-based resin may include a polypropylene homopolymer, an ethylene-propylene block copolymer, or a mixture thereof.

In embodiments, the polypropylene-based resin may have a melt index (MI) of 40 to 120 g/10 min (230° C., 2.16 kg).

In embodiments, the ethylene-α-olefin copolymer may include a copolymer of ethylene and at least one α-olefin selected from α-olefins having 3 to 10 carbon atoms.

In embodiments, the α-olefin may include at least one selected from the group of propylene, 1-butene, 1-pentene, 1-hexene, 1-heptene, and 1-octene.

In embodiments, the ethylene-α-olefin copolymer may have a melt index (MI) of 0.1 to 20 g/10 min (230° C., 2.16 kg).

In embodiments, the ethylene-α-olefin copolymer may have a Mooney viscosity of 10 to 50 and a crystallinity of 1 to 20.

In embodiments, the anti-scratch additive may be a siloxane masterbatch.

In embodiments, the inorganic filler may include at least one selected from the group of talc, calcium carbonate, clay, whisker, kaolin, barium sulfate, wollastonite, mica, clay, magnesium hydroxide, titanium oxide, carbon black, glass bubbles, and glass fiber.

In embodiments, the polypropylene resin composition may further include a functional additive including at least one selected from the group of an antioxidant, an ultraviolet absorber, a nucleating agent, a coupling agent, a dispersant, a lubricant, a slip agent, a flame retardant, an effect pigment, an organic and inorganic pigment, a heat stabilizer, a weather stabilizer, and an antistatic agent.

In embodiments, the antioxidant may include at least one selected from the group of a phenol-based antioxidant and a phosphorus-based antioxidant.

In embodiments, the polypropylene resin composition may include 0.1 to 0.5 wt. % of the phenol-based antioxidant, 0.1 to 0.5 wt. % of the phosphorus-based antioxidant, 0.1 to 0.5 wt. % of the lubricant, 0.5 to 5 wt. % of the effect pigment, and 0.1 to 3 wt. % of the organic and inorganic pigment.

Another aspect of the present disclosure provides a molded article obtained by two-shot injection molding of the polypropylene resin composition and a recycled resin composition.

In embodiments, the polypropylene resin composition according to the present disclosure may minimize shear stress generated in the cavity and have high viscoelasticity, thereby inducing smooth flow of the recycled material.

In addition, the polypropylene resin composition according to the present disclosure may prevent the occurrence of flow marks on the surface of the molded article.

Further, the polypropylene resin composition according to the present disclosure may exhibit improved processability and aesthetics.

### DETAILED DESCRIPTION

The present disclosure will be described in further detail below with reference to exemplary embodiments. However, the following exemplary embodiments are provided merely as references for describing the present disclosure in detail, and the present disclosure is not limited thereto and may be implemented in various forms.

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

In the present specification, “Mooney viscosity” refers to the Mooney viscosity (ML1+4@121° C.) measured according to ASTM D1646 at 121° C.

Hereinafter, the composition components constituting the polypropylene resin composition according to one embodiment of the present disclosure will be described in more detail.

### (a) Polypropylene-Based Resin

The polypropylene resin composition according to one embodiment of the present disclosure includes a polypropylene-based resin as a base resin. The polypropylene-based resin may include a polypropylene homopolymer, an ethylene-propylene block copolymer, a propylene-1-butene block copolymer, a propylene-1-hexene block copolymer, or a mixture thereof. Specifically, the polypropylene-based resin may include a polypropylene homopolymer, an ethylene-propylene block copolymer, or a mixture thereof.

In a particular embodiment, the polypropylene-based resin may include an ethylene-propylene block copolymer, wherein the polypropylene-based resin is a copolymer polymerized from 70 to 99 wt. % of a propylene monomer and 1 to 30 wt. % of an ethylene monomer, and specifically, from 95 to 99 wt. % of a propylene monomer and 1 to 5 wt. % of an ethylene monomer. When the content of the ethylene monomer constituting the polypropylene-based resin is less than 1 wt. %, the applicability may deteriorate due to decreased impact resistance. On the other hand, when the content exceeds 30 wt. %, the rigidity of the molded article may decrease. Both cases are undesirable.

The polypropylene-based resin may have a melt index (MI) of 40 to 120 g/10 min (230° C., 2.16 kg), and specifically, 70 to 110 g/10 min (230° C., 2.16 kg). When the melt index (MI) of the polypropylene-based resin is less than 40 g/10 min (230° C., 2.16 kg), the moldability may deteriorate due to reduced flowability. On the other hand, when the melt index (MI) of the polypropylene-based resin exceeds 120 g/10 min (230° C., 2.16 kg), the impact strength may decrease. Both cases are undesirable.

The density of the polypropylene-based resin may range from 0.850 to 0.950 g/cm³, and specifically, from 0.900 to 0.920 g/cm³, but is not limited thereto.

The polypropylene-based resin may have a heat deflection temperature of at least 120° C., and specifically at least 125° C., and up to 200° C., and specifically up to 180° C. or 160° C., but is not limited thereto as long as the objectives of the present disclosure can be achieved.

The polypropylene-based resin may be included in an amount of 30 to 80 wt. %, and specifically 40 to 65 wt. %, based on 100 wt. % of the total resin composition. When the content of the polypropylene-based resin is less than 30 wt. %, the rigidity of the resin composition may decrease, and the heat resistance may be reduced, making it difficult for the molded article to sufficiently achieve the required performance. When the content of the polypropylene-based resin exceeds 80 wt. %, the impact resistance may decrease, which is undesirable.

### (b) Ethylene-α-Olefin Copolymer

The polypropylene resin composition according to one embodiment of the present disclosure may include an ethylene-α-olefin copolymer as an elastic material to provide elasticity and flexibility and to enhance impact resistance.

The ethylene-α-olefin copolymer may include a copolymer of ethylene and at least one α-olefin selected from α-olefins having 3 to 10 carbon atoms. Specifically, the ethylene-α-olefin copolymer may include: an olefin copolymer formed by copolymerizing ethylene and at least one α-olefin monomer selected from the group of propylene, 1-butene, 1-pentene, 1-hexene, 1-heptene, and 1-octene; a terpolymer; an olefin block copolymer formed by block copolymerization of α-olefin monomers; or a graft copolymer in which one type of α-olefin monomer constitutes the backbone chain structure of the copolymer and another type of α-olefin monomer is bonded in a branched form. The ethylene-α-olefin copolymer may have a chemical structure in which side chains of the polyolefin structure are extended with carbon chains having 4, 6, or 8 carbon atoms.

The ethylene-α-olefin copolymer may be included in an amount of 5 to 30 wt. % based on 100 wt. % of the total resin composition. When the content of the ethylene-α-olefin copolymer is less than 5 wt. %, the impact properties may deteriorate. On the other hand, when the content exceeds 30 wt. %, the rigidity may decrease, and the ductility may increase, leading to the degradation of mechanical properties such as flexural modulus. Both cases are undesirable

The melt index (MI) of the ethylene-α-olefin copolymer may range from 0.1 to 20 g/10 min (190° C., 2.16 kg), and specifically, from 0.5 to 15 g/10 min (190° C., 2.16 kg), and more specifically, from 1 to 10 g/10 min (190° C., 2.16 kg), but is not limited thereto as long as the objectives of the present disclosure can be achieved.

The Mooney viscosity of the ethylene-α-olefin copolymer may range from 10 to 100, and specifically from 15 to 80, and more specifically from 20 to 50. When this condition is satisfied, flow marks may be minimized.

The density of the ethylene-α-olefin copolymer may range from 0.800 to 0.900 g/cm³, and specifically, from 0.855 to 0.890 g/cm³, but is not limited thereto.

The ethylene-α-olefin copolymer according to one embodiment of the present disclosure may include a first ethylene-α-olefin copolymer and a second ethylene-α-olefin copolymer. By adjusting the content of ethylene-α-olefin copolymers having different properties, the occurrence of flow marks during molding may be prevented, thereby providing a molded article with improved appearance quality.

The Mooney viscosity of the first ethylene-α-olefin copolymer according to one embodiment of the present disclosure may be lower than that of the second ethylene-α-olefin copolymer. Specifically, the Mooney viscosity (M2) of the second ethylene-α-olefin copolymer and the Mooney viscosity (M1) of the first ethylene-α-olefin copolymer may have a ratio (M2/M1) ranging from 2 to 10, and more specifically from 3 to 5. When the above range is satisfied, the length of flow marks may be minimized.

### (c) Anti-Scratch Additive

The polypropylene resin composition according to one embodiment of the present disclosure may include an anti-scratch additive to provide scratch resistance and improve the quality of the molded article. The anti-scratch additive may be a siloxane masterbatch, but is not limited thereto. The siloxane masterbatch may be a polypropylene-siloxane masterbatch of 50 wt. % polypropylene and 50 wt. % ultra-high molecular weight (UHMW) siloxane resin.

The siloxane masterbatch may further improve surface properties, for example, by enhancing slip characteristics and increasing resistance to marring and scratching. Additionally, it may prevent the migration of fluids and other additives that can occur when using silicone materials.

The anti-scratch additive may be included in an amount of 1 to 5 wt. %, and more specifically 2 to 3 wt. %, based on 100 wt. % of the total resin composition. When the content of the anti-scratch additive is less than 1 wt. %, the improvement in scratch resistance may be insufficient, whereas when it exceeds 5 wt. %, further enhancement in scratch resistance may be difficult to achieve, and excessive addition may instead lead to increased costs.

### (d) Inorganic Filler

The polypropylene resin composition according to one embodiment of the present disclosure may include an inorganic filler to improve the structural strength of the molded article. The inorganic filler may include at least one selected from the group of talc, calcium carbonate, clay, whisker, kaolin, barium sulfate, wollastonite, mica, clay, magnesium hydroxide, titanium oxide, carbon black, glass bubbles, and glass fiber. Specifically, the inorganic filler may include talc, which is particularly suitable as the inorganic filler of the present disclosure due to its improved effect in reinforcing properties such as flexibility, rigidity, and low-temperature impact resistance in the resin composition. However, as the average particle size of the talc exceeds 7 μm, the effect of reinforcing rigidity may deteriorate, and when it excessively exceeds 7 μm, the shape of the filler may become visible on the surface of the molded article. Therefore, it is be preferable for the talc to have an average particle size of 7 μm or less. On the other hand, using talc with an excessively small particle size may cause difficulties in processing and content control. Accordingly, it is suitable for the talc to have an average particle size ranging from 3.0 to 7.0 μm.

The inorganic filler may be included in an amount of 5 to 35 wt. % based on 100 wt. % of the total resin composition. When the content of the inorganic filler is less than 5 wt. %, the effect of reinforcing rigidity is low, and shrinkage rate improvement is difficult. On the other hand, when the content of the inorganic filler exceeds 35 wt. %, the specific gravity increases, making it difficult to achieve weight reduction effects.

### (e) Processing Aid

The polypropylene resin composition according to one embodiment of the present disclosure may include a processing aid to increase the melt index of the resin composition. The processing aid may be at least one selected from the group of a carboxylic acid derivative-based processing aid and a dendrimer.

The processing aid may be included in an amount of 0.1 to 0.5 wt. %, and more specifically, 0.2 to 0.4 wt. %, based on 100 wt. % of the total resin composition. When the above range is satisfied, the melt index of the resin composition may be efficiently increased.

### (f) Functional Additive

The polypropylene resin composition according to one embodiment of the present disclosure may additionally include functional additives that are conventionally used in the technical field. For example, the functional additive may further include at least one selected from the group of an antioxidant, an ultraviolet absorber, a nucleating agent, a coupling agent, a dispersant, a lubricant, a slip agent, a flame retardant, an effect pigment, an organic and inorganic pigment, a heat stabilizer, a weather stabilizer, and an antistatic agent.

The antioxidant may include at least one selected from the group of a phenol-based antioxidant and a phosphorus-based antioxidant.

The dispersant or lubricant may improve the dispersibility of pigments and inorganic fillers such as talc and reduce shear stress generated during processing. Additionally, the antioxidant may prevent a decrease in the molecular weight of the polyolefin by inhibiting its degradation caused by shear stress and the like. The antioxidant may include at least one selected from the group of a phenolic antioxidant, a phosphite antioxidant, a thiodipropionate antioxidant, and combinations thereof.

The UV absorber may be included in the polypropylene resin composition to block or absorb ultraviolet rays that degrade polymer chains, thereby preventing changes in the properties and appearance of the polymer, such as aging. The UV absorber may include at least one selected from the group of hydroxyl benzophenone, benzotriazoles, and combinations thereof.

The effect pigment may include at least one selected from the group of aluminum, brass, and mica, which impart a metallic texture.

The organic and inorganic pigments may include an organic pigment including a phthalocyanine-based pigment with lightfastness and/or an inorganic pigment including titanium dioxide, carbon black, or a pigment masterbatch.

The polypropylene resin composition according to one embodiment of the present disclosure may include, based on 100 wt. % of the total resin composition, 0.1 to 0.5 wt. % of the phenolic antioxidant, 0.1 to 0.5 wt. % of the phosphorus-based antioxidant, 0.1 to 0.5 wt. % of the lubricant, 0.5 to 5 wt. % of the effect pigment, and 0.1 to 3 wt. % of the organic and inorganic pigments, but it is not limited thereto.

The following describes a molded article according to another embodiment of the present disclosure. Another embodiment of the present disclosure may provide a molded article obtained by two-shot injection molding of the polypropylene resin composition according to one embodiment of the present disclosure and a recycled resin composition. Specifically, the molded article may include a surface layer formed from the polypropylene resin composition and an inner layer formed from the recycled resin composition. The molded article may be an unpainted molded article, without the need for separate painting.

The melt index (MI) of the recycled resin composition according to one embodiment of the present disclosure may range from 10 to 35 g/10 min (190° C., 2.16 kg), and more specifically from 20 to 30 g/10 min (190° C., 2.16 kg), but is not limited thereto as long as the objectives of the present disclosure can be achieved.

The melt index of the polypropylene resin composition according to one embodiment of the present disclosure may be greater than that of the recycled resin composition. When this condition is satisfied, flow marks may be minimized, and at the end of the mold, the polypropylene resin composition may be prevented from being less flowable than the recycled resin composition, thereby preventing the exposure of the inner layer formed from the recycled resin composition. Additionally, mixing of the polypropylene resin composition and the recycled resin composition due to jetting may be prevented.

The specific gravity of the recycled resin composition, measured according to ISO 1183, may range from 1.00 to 1.10, and more specifically from 1.03 to 1.05, but is not limited thereto as long as the objectives of the present disclosure can be achieved.

In the case of the recycled resin composition according to one embodiment of the present disclosure, the recycled resin composition may include at least 50 wt. % of recycled resin recovered from end-of-life vehicles (ELVs) based on the total weight, and specifically, at least 60 wt. % or at least 70 wt. %.

The following describes various examples and comparative examples of the present disclosure. However, the following examples are merely various examples of the present disclosure, and the present disclosure is not intended to be limited thereto.

### Examples 1 and 2, and Comparative Examples 1 to 3

The components listed in Table 1 were added to a mixer in the indicated amounts, mixed, and then fed into an extruder and melt-blended to produce the resin composition.

TABLE 1

| | | Examples | | Comparative Examples | | |
|---|---|---|---|---|---|---|
| | | 1 | 2 | 1 | 2 | 3 |
| Ethylene-propylene | | 50 | 50 | 50 | 50 | 70 |
| block copolymer | | | | | | |
| First ethylene-α-olefin | | — | 10 | 15 | 20 | 10 |
| copolymer | | | | | | |
| Second ethylene-α-olefin | | 20 | 10 | 5 | — | 10 |
| copolymer | | | | | | |
| Polypropylene-silicone | | 3 | 3 | 3 | 3 | 3 |
| masterbatch | | | | | | |
| Inorganic filler | | 30 | 30 | 30 | 30 | 10 |
| Processing aid | | 0.4 | 0.4 | — | — | — |
| Functional | Phenolic | 0.1 | 0.1 | 0.1 | 0.1 | 0.1 |
| additive | antioxidant | | | | | |
| | Phosphite | 0.1 | 0.1 | 0.1 | 0.1 | 0.1 |
| | antioxidant | | | | | |
| | Lubricant | 0.2 | 0.2 | 0.2 | 0.2 | 0.2 |
| | Glossy | 3 | 3 | 3 | 3 | 3 |
| | pigment | | | | | |
| | Pigment | 0.5 | 0.5 | 0.5 | 0.5 | 0.5 |

The composition components listed in Table 1 and the characteristics of each component are shown below.

### <Composition Components>

### (1) Polypropylene-Based Resin

An ethylene-propylene block copolymer with a melt index of 110 g/10 min (230° C., 2.16 kg), density of 0.91 g/cm³, heat deflection temperature of 125° C., and an ethylene content of 3.0-5.0 wt. % was used.

### (2) Ethylene-α-Olefin Copolymer

The first ethylene-α-olefin copolymer with a density of 0.875 g/cm³, melt index of 3 g/10 min (190° C., 2.16 kg), and Mooney viscosity of 11, and the second ethylene-α-olefin copolymer with a density of 0.860 g/cm³, melt index of 0.3 g/10 min (190° C., 2.16 kg), and Mooney viscosity of 47 were used.

### (3) Anti-Scratch Additive

A masterbatch of 50 wt. % polypropylene and 50 wt. % ultra-high molecular weight (UHMW) siloxane resin was used.

### (4) Inorganic Filler

Talc with an average particle size of 3.0 to 7.0 μm was used.

### (5) Functional Additive

The components and characteristics of the functional additive are described below.

1) Lubricant: Ethylene bis stearamide was used as a stearic acid compound. The lubricant functions to reduce the shear stress generated during the composition manufacturing process. In addition to ethylene bis stearamide, magnesium stearate and calcium stearate may also be used.

2) Antioxidant: The phenolic antioxidant used was BASF's Irganox 1010, and the phosphite antioxidant used was BASF's Irgafos 168. The antioxidants function to prevent quality degradation caused by oxidation and thermal decomposition during manufacture or use.

3) Effect Pigment: An aluminum pigment, containing 20-30 wt. % of PP or wax as the carrier and having an average particle size of 5 to 95 μm, was used as an aluminum-based effect pigment. The aluminum pigment provides optical properties such as reflectivity, visual refraction, and light interference, allowing for the creation of a metallic luster.

4) Organic and Inorganic Pigments: To impart a white (bright) color, titanium dioxide was used, and to impart a black (dark) color, high black carbon was used.

### (6) Processing Aid

The processing aid used was a BYK-MAX P product.

### <Physical Property Evaluation>

The physical property measurement results for the resin compositions of the above examples and comparative examples, and for the specimens produced by injection molding the resin compositions through an injection molding machine and leaving them at room temperature, are listed in Table 2 below. The measurement methods for each measurement item are as follows.

Additionally, the physical property measurement results for the recycled resin composition and the specimens produced from the recycled resin composition in the same manner as above are listed in Table 3 below.

(1) Flow marks: The specimen, produced by injection molding using a combustible mold with a cavity thickness of 1.5T, was inspected under a light source to check for the presence of uneven shapes around the weld line and along the outer edges of the specimen.

(2) Melt index: Measured at 230° C. under a 2.16 kg load according to ISO 1133.

(3) Specific gravity: Measured according to ISO 1183.

(4) Tensile yield strength: Measured according to ISO 527.

(5) Flexural modulus: Measured according to ISO 178.

(6) Izod impact strength: Measured at room temperature according to ISO 180.

(7) Heat deflection temperature (HDT): Measured according to the method specified in ISO 75.

(8) Shrinkage rate: After injection molding an ASTM tensile specimen and conditioning it for over 24 hours, the difference between the initial and post-shrinkage lengths was measured and recorded in units of 1/1000.

(9) Die swell ratio: Evaluated by an accredited institution.

TABLE 2

| | Examples | | Comparative Examples | | |
|---|---|---|---|---|---|
| | 1 | 2 | 1 | 2 | 3 |
| Melt Index (g/10 min) 230° C., 2.16 kg | 47 | 52 | 55 | 58 | 49 |
| Specific gravity | 1.1 | 1.1 | 1.1 | 1.1 | 0.97 |
| Tensile yield strength (MPa) | 17.7 | 18 | 18.7 | 19 | 17.5 |
| Flexural modulus (MPa) | 1,900 | 1,950 | 2,005 | 2,100 | 1,420 |
| Izod impact strength (kJ/m²) | 37 | 35 | 33 | 29 | 40 |
| Heat deflection temperature at 0.45 MPa (° C.) | 105 | 107 | 108 | 110 | 88 |
| Shrinkage rate (1/1000) | 6.6 | 6.8 | 6.9 | 7.1 | 9.5 |
| Die swell ratio(240° C.) | 1.8 | 1.6 | 1.5 | 1.4 | 1.6 |

TABLE 3

| | Recycled resin |
|---|---|
| | composition |
| Melt Index (g/10 min) 230° C., 2.16 kg | 24 |
| Specific gravity | 1.05 |
| Tensile yield strength (MPa) | 23 |
| Flexural modulus (MPa) | 2,200 |
| Izod impact strength (kJ/m²) | 5.5 |
| Heat deflection temperature at 0.45 MPa (° C.) | 117 |
| Shrinkage rate (1/1000) | 12 |

Referring to Tables 2 and 3, the resin composition according to the examples of the present disclosure exhibited a lower shrinkage rate compared to the recycled resin composition. Additionally, the resin composition has a high melt index, which may minimize the shear stress occurring in the mold cavity, and a large Die Swell Ratio that results in high viscoelasticity, enabling immediate spreading and contact within the mold cavity during two-shot injection molding. On the other hand, Comparative Example 3, which has a lower content of inorganic filler and does not contain a processing aid, exhibited higher shrinkage rate and a lower melt index compared to Example 2 Therefore, the polypropylene resin composition of the present disclosure may facilitate smooth flow when recycled material is used in the inner layer, preventing the occurrence of flow marks on the molded article. Accordingly, the polypropylene resin composition of the present disclosure is confirmed to be suitable for the surface layer in the two-shot injection molding.

The features, structures, effects, and the like described in the exemplary embodiments above are included in at least one embodiment of the present disclosure and are not necessarily limited to a single embodiment. Furthermore, the features, structures, effects, and the like exemplified in each exemplary embodiment can be combined or modified in other embodiments by those skilled in the art to which the embodiments pertain. Therefore, such combinations and modifications should be construed as being within the scope of the present disclosure.

What is claimed is:

1. A polypropylene resin composition, comprising:
30 to 80 wt. % of a polypropylene-based resin;
5 to 30 wt. % of an ethylene-α-olefin copolymer;
1 to 5 wt. % of an anti-scratch additive;
5 to 35 wt. % of an inorganic filler; and
0.1 to 0.5 wt. % of a processing aid.

2. The polypropylene resin composition according to claim 1, wherein the polypropylene-based resin comprises a polypropylene homopolymer, an ethylene-propylene block copolymer, or a mixture thereof.

3. The polypropylene resin composition according to claim 1, wherein the polypropylene-based resin has a melt index (MI) of 40 to 120 g/10 min (230° C., 2.16 kg).

4. The polypropylene resin composition according to claim 1, wherein the ethylene-α-olefin copolymer comprises a copolymer of ethylene and at least one α-olefin selected from α-olefins having 3 to 10 carbon atoms.

5. The polypropylene resin composition according to claim 4, wherein the α-olefin comprises one or more of propylene, 1-butene, 1-pentene, 1-hexene, 1-heptene, 1-octene, or any combination thereof.

6. The polypropylene resin composition according to claim 1, wherein the ethylene-α-olefin has a melt index (MI) of 0.1 to 20 g/10 min (230° C., 2.16 kg).

7. The polypropylene resin composition according to claim 1, wherein the ethylene-α-olefin copolymer has a Mooney viscosity of 10 to 50 and a crystallinity of 1 to 20.

8. The polypropylene resin composition according to claim 1, wherein the anti-scratch additive is a siloxane masterbatch.

9. The polypropylene resin composition according to claim 1, wherein the inorganic filler comprises one or more of talc, calcium carbonate, clay, whisker, kaolin, barium sulfate, wollastonite, mica, clay, magnesium hydroxide, titanium oxide, carbon black, glass bubbles, glass fiber, or any combination thereof.

10. The polypropylene resin composition according to claim 1, further comprising a functional additive comprising one or more of an antioxidant, an ultraviolet absorber, a nucleating agent, a coupling agent, a dispersant, a lubricant, a slip agent, a flame retardant, an effect pigment, an organic and inorganic pigment, a heat stabilizer, a weather stabilizer, an antistatic agent, or any combination thereof.

11. The polypropylene resin composition according to claim 10, wherein the antioxidant comprises one or more of a phenol-based antioxidant, a phosphorus-based antioxidant, or any combination thereof.

12. The polypropylene resin composition according to claim 11, wherein a content of the phenol-based antioxidant is 0.1 to 0.5 wt. %, a content of the phosphorus-based antioxidant is 0.1 to 0.5 wt. %, a content of the lubricant is 0.1 to 0.5 wt. %, a content of the effect pigment is 0.5 to 5 wt. %, and a content of the organic and inorganic pigments is 0.1 to 3 wt. %.

13. A molded article obtained by two-shot injection molding of the polypropylene resin composition according to claim 1 and a recycled resin composition.
